(19) United States
(12) Patent Application Publication
(10) Pub. No.: US 2015/0079285 A1
(43) Pub. Date: Mar. 19, 2015

(54) WRITING DEVICE FOR SINGLE-DIGIT USE

(71) Applicant: Beckie Bottjer, Mesa, AZ (US)

(72) Inventor: Beckie Bottjer, Mesa, AZ (US)

(21) Appl. No.: 14/486,544

(22) Filed: Sep. 15, 2014

Related U.S. Application Data
(60) Provisional application No. 61/877,412, filed on Sep. 13, 2013.

(51) Int. Cl. B43K 25/00; B43K 23/00

(52) U.S. Cl. CPC B43K 25/00; B43K 23/001
USPC 427/256; 401/131

(57) ABSTRACT

An adjustable writing device is provided. The adjustable writing device has a digit engaging member that has an adjustable diameter for functionally engaging a portion of a user's digit without substantially impeding articulation of the digit. The writing device has a cartridge engaging member that includes a writing tip coupled to the cartridge engaging member and an ink cartridge adapted to communicate with the cartridge engaging member to allow ink within the ink cartridge to be dispensed from the writing tip. The writing tip can be oriented substantially orthogonal to an axis of the digit engaging member. A friction fit between the digit engaging member and the digit prevents the writing tip from rotating about the digit.

### CROSS REFERENCE TO RELATED APPLICATION

This application claims priority to U.S. Provisional patent application to Bottjer entitled “WRITING DEVICE FOR SINGLE-DIGIT USE,” Ser. No. 61/877,412, filed Sep. 13, 2013, the disclosure of which is hereby incorporated entirely herein by reference.

### BACKGROUND

1. Technical Field

The following relates generally to writing instruments, and in particular to a writing device that may be operated by single-digit use.

2. State of the Art

In many work environments, a writing instrument is integral to the completion of one's job. However, a problem arises when the job requires occasional, rather than continuous, use of the writing instrument. This is because, in most cases, both cannot be used at the same time—the complexities of the job require, at times, that the fingers are used without the burden of holding the writing instrument and, at other times, that the fingers manipulate the writing instrument to write.

Such a situation introduces inefficiency into the job to be completed. For example, when a writing instrument must be set down and picked back up time and time again, significant time and effort may be wasted. When setting the writing instrument down, so that it does not roll away, one must turn away from the work being done and purposefully place the writing instrument on a level surface or other object. Moreover, every time the writing instrument is needed again, one must turn away from the task at hand, find the writing instrument to be used, and thereafter refocus on the task at hand. This transition between using the writing instrument, putting the writing instrument down to use one's fingers and hands without the writing instrument, and picking back up the writing instrument can be wasteful of one's time and inefficient in one's efforts. It is also cumbersome, repetitive, and even irritating in its monotony.

It would therefore be very desirable and useful to have a new and improved writing device that can be deployed by a user without having to set it down or pick it back up. And, in addition thereto, the writing device should not impede one's efforts in performing the task at hand that requires occasional use of a writing instrument.

### SUMMARY

The present disclosure relates to writing instruments, and in particular to a writing device that may be operated by single-digit use.

A first general aspect relates to an adjustable holder for a writing instrument, the holder comprising a digit engaging member, wherein the digit engaging member has an axis and an adjustable diameter for functionally engaging a portion of a user's digit without substantially impeding articulation of the digit, and an instrument engaging member functionally coupled to the digit engaging member, the instrument engaging member configured to receive the writing instrument, wherein under the condition the writing instrument is functionally engaged by the instrument engaging member, a length of the writing tip of the writing instrument is oriented substantially orthogonally to the axis of the digit engaging member.

Another general aspect relates to wherein the digit engaging member is configured to repeatedly and releasably engage the portion of the user's digit.

Another general aspect relates to wherein the digit engaging member engages the user's digit between neighboring joints of the digit without impeding articulation of the digit.

Another general aspect relates to wherein the instrument engaging member is configured to rotate with respect to the digit engaging member between an orthogonal position wherein the length of the writing tip and the axis of the digit engaging member are substantially orthogonal to one another and a parallel position wherein the length of the writing tip and the axis of the digit engaging member are substantially parallel with one another.

Another general aspect relates to wherein the instrument engaging member is configured to releasably and repeatedly couple to the digit engaging member.

Another general aspect relates to wherein the instrument engaging member is configured to releasably and repeatedly engage the writing instrument.

Another general aspect relates to wherein the length of the writing tip of the writing instrument is fixedly oriented substantially orthogonally to the axis of the digit engaging member.

Another general aspect relates to wherein the writing device is inserted on a thumb of the user.

Another general aspect relates to an adjustable writing device, the writing device comprising a digit engaging member, wherein the digit engaging member has an adjustable diameter for functionally engaging a portion of a user's digit without substantially impeding articulation of the digit, an instrument engaging member functionally coupled to the digit engaging member, a writing tip functionally coupled to the instrument engaging member, and a cartridge adapted to communicate with the instrument engaging member to allow ink within the cartridge to be dispensed from the writing tip.

Another general aspect relates to wherein the digit engaging member is configured to repeatedly and releasably engage the portion of the user's digit.

Another general aspect relates to wherein the digit engaging member engages the user's digit between neighboring joints of the digit without impeding articulation of the digit.

Another general aspect relates to wherein the instrument engaging member is configured to rotate with respect to the digit engaging member.

Another general aspect relates to wherein the instrument engaging member is configured to releasably and repeatedly couple to the digit engaging member.

Another general aspect relates to wherein the writing tip is configured to releasably and repeatedly couple to the instrument engaging member.

Another general aspect relates to wherein the cartridge is configured to releasably and repeatedly couple to the instrument engaging member on an opposing end of the instrument engaging member from the writing tip.

Another general aspect relates to wherein the writing device is inserted on a thumb of the user.

Another general aspect relates to a method of utilizing a writing device, the method comprising coupling a writing instrument to the writing device, coupling the writing device to a digit on a hand of a user such that a length of the writing instrument is oriented substantially orthogonally to an axis of the digit on which the device is coupled, and operating the writing instrument by movement of the digit.

Another general aspect relates to a digit engaging member defining an opening and the opening defining an axis, wherein the coupling the writing device on a digit on a hand of a user further comprises inserting the digit into the opening, the opening being configured to repeatedly and releasably couple the writing device to the digit.

Another general aspect relates to wherein the coupling a writing instrument to the writing device further comprises inserting the writing instrument through a sleeve defined by the writing device, the sleeve being configured to engage the writing instrument.

Another general aspect relates to wherein the operating the writing device further comprises: inserting the writing device on a user's thumb; moving the thumb to make one or more markings on a first object; and operating a second object in the user's hand having the device thereon between the one or more markings without removing the device from the user's thumb.

The foregoing and other features, advantages, and construction of the present disclosure will be more readily apparent and fully appreciated from the following more detailed description of the particular embodiments, taken in conjunction with the accompanying drawings.

### BRIEF DESCRIPTION OF THE DRAWINGS

Some of the embodiments will be described in detail, with reference to the following figures, wherein like designations denote like members.

FIG. 1 is a side perspective view of an embodiment of an adjustable writing device in accordance with the present disclosure.

FIG. 2 is a side view of an embodiment of an adjustable writing device in accordance with the present disclosure.

FIG. 3 is a rear perspective view of an embodiment of an adjustable writing device in accordance with the present disclosure.

FIG. 4 is a front perspective view of an embodiment of an adjustable writing device in accordance with the present disclosure.

FIG. 5 is a side perspective view of an embodiment of an adjustable writing device being utilized by a user in accordance with the present disclosure.

FIG. 6 is a side perspective view of an embodiment of an adjustable writing device being utilized by a user in accordance with the present disclosure.

### DETAILED DESCRIPTION OF EMBODIMENTS

A detailed description of the hereinafter described embodiments of the disclosed apparatus and method are presented herein by way of exemplification and not limitation with reference to the Figures listed above. Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure.

As a preface to the detailed description, it should be noted that, as used in this specification and the appended claims, the singular forms “a”, “an” and “the” include plural referents, unless the context clearly dictates otherwise.

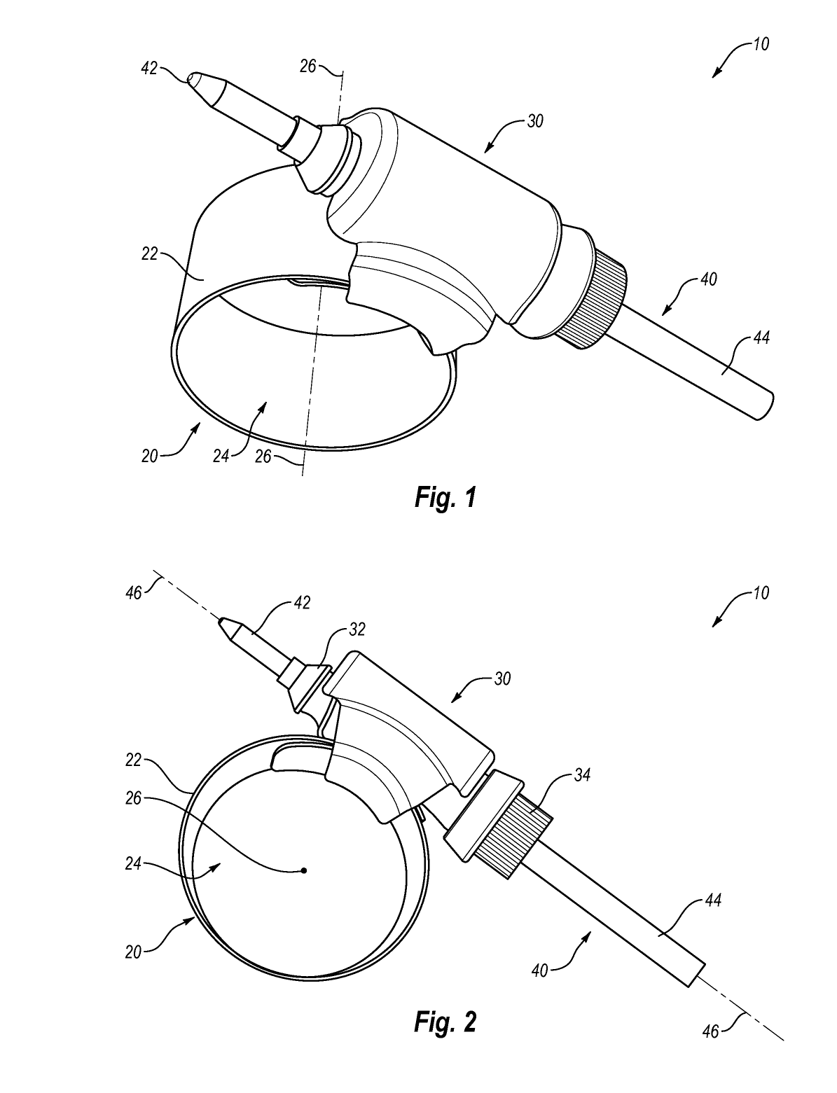

Referring to the drawings, FIG. 1 depicts an embodiment of an adjustable writing device 10 in accordance with the present disclosure. The writing device 10 may further comprise various structural components that complement one another to provide the unique functionality and performance of the writing device 10, the structure and function of which will be described in greater detail herein. For example, embodiments of the writing device 10 may comprise, among other components, a digit engaging member 20, an instrument engaging member 30, and a writing utensil 40.

Embodiments of the adjustable writing device 10 may comprise a digit engaging member 20. The digit engaging member 20 may comprise an engagement body 22 that defines an engagement opening 24 that may be configured to be releasably and repeatedly coupled to and disengaged from a digit of a user.

Embodiments of the engagement body 22 may be comprised of a rigid materials, such as metal, plastic, or composite materials of similar properties that may retain the shape of the engagement body 20 as it functionally engages the digit of the user. The engagement opening 24 may have a diameter that can be adjusted by altering or otherwise changing a length of the engagement body 22. The diameter of the engagement opening 24 may be adjusted as needed to functionally engage the digit of the user. For larger diameter digits, the diameter of the engagement opening 24 may be enlarged accordingly. Similarly, for smaller diameter digits, the diameter of the engagement opening 24 may be reduced accordingly. The engagement opening 24 may be configured to be slid onto the digit of the user. In other words, the engagement opening 24 may functionally engage the digit of a user much like a ring might engage the digit of a user. The engagement opening 24 may provide a friction fit with the digit, so as to secure the device 10 onto the digit. In addition, the diameter of the engagement opening 24 may be adjusted after the device 10 is placed on the digit to securely snug the device 10 onto the digit and substantially prevent unwanted movement of the device 10. The diameter of the engagement opening 24 may be altered by such means as are now known in the art or later developed, such as for example, but not limited thereto, by straps, buttons, hooks, hook and loop fasteners, belts, loops, zippers, elastic, adhesive, worm gears, clamps, etc. In addition, the diameter of the engagement opening 24 may be altered by adjusting the length of the engagement body 22 with respect to itself by such means as those described above, for example, but not limited thereto, by straps, buttons, hooks, hook and loop fasteners, belts, loops, zippers, elastic, adhesive, worm gears, clamps, etc. The engagement opening 24 may define an axis 26.

Embodiments of the adjustable writing device 10 may further comprise the engagement body 22 being made of flexible material, such as stretch material or elastic material. Under these conditions, the engagement body 22 may be stretched from its normal diameter and placed onto the digit of the user. Once over the digit, the flexible engagement body 22 may be released so as to return to its normal diameter and snugly engage the digit of the user and remain in place on the digit.

Embodiments of the adjustable writing device 10 may further comprise the engagement body 22 having an axial width that is large enough to resist and substantially prevent the engagement body 22 from axially advancing along, radially spinning about, or pivoting on the digit of the user in response to forces acting on the device 10. In other words, the engagement body 22 may have a width that provides sufficient stability, support, and friction to prevent undesired movement of the engagement body 22 on the digit. Moreover, the width of the engagement body 22 may yet be small enough to fit onto the proximal phalanges, the intermediate phalanges, and/or the distal phalanges of the user. In this way, the width of the engagement body 22 may allow the user to place the writing device 10 on one of the phalanges and thereafter use the normal articulation of the hand, and especially the fingers and thumb of the hand, despite the presence of the writing device 10 on the fingers and/or thumb. In other words, the width of the engagement body 22 may be configured to be less than the distance between neighboring joints of the digit on which the device 10 is placed so as to not interfere with the articulation of the joints between the phalanges.

Embodiments of the adjustable writing device 10 may further comprise the engagement body 22 having slits, gaps, openings, slots and/or holes to allow the user's skin under the engagement body 22 to breathe with the ambient air. These slits, gaps, openings, slots and/or holes may be positioned haphazardly around the body 22 or may be placed intermittently on the body 22. In this way, moisture from the user's skin can ventilate with the ambient air and thus evaporate without causing build-up of moisture and sweat that might otherwise cause the engagement body 22 to slip or displace on the user's digit.

Embodiments of the adjustable writing device 10 may further comprise an instrument engaging member 30. The instrument engaging member 30 may be configured to functionally engage a writing instrument 40. Embodiments of the instrument engaging member 30 may be configured to be coupled to the digit engaging member 20, such that the digit engaging member 20 may support the instrument engaging member 30 thereon and/or thereby. The instrument engaging member 30 may be configured to releasably and repeatedly couple to and disengage from the digit engaging member 20 by the coupling means 38, so as to possibly be exchanged with other or additional instrument engaging members 30. The coupling means 38 may be cooperating brackets, adhesive, hook and loop fastener, snaps, belts, slide on clips, ties, or other releasable coupling means known in the art. Alternatively, the instrument engaging member 30 may be configured to be fixedly coupled to the digit engaging member 20 by coupling means 38. The coupling means 38 may further comprise welds, seals, permanent adhesive, or other permanent coupling mechanisms known in the art. Embodiments of the device 10 may further comprise the digit engaging member 20 and the instrument engaging member 30 being comprised of a single integral piece, wherein the digit engaging member 20 and the instrument engaging member 30 are a unitary body that yet permits the diameter of the digit engaging member 20 to be adjusted.

As depicted clearly in FIG. 4, embodiments of the device 10 may further comprise the instrument engaging member 30 defining an axial sleeve or slot 36 running through the entire axial length of the instrument engaging member 30, the slot 36 being configured to receive therein and there through the writing instrument 40, such that a tip 42 of the writing instrument 40 may be inserted into the axial slot 36 and pushed through the axial slot 36 so as to extend out one side of the instrument engaging member 30. A body 44 of the writing instrument 40 may extend out the other side of the instrument engaging member 30. The body 44 may be configured to hold ink, pigments, dyes, liquids, pastes, or other marking material that may facilitate the tip 42 being able to leave marks, designs, text or images, on objects such as paper and the like. The axial slot 36 may be configured to functionally engage the writing instrument 40 by friction fit. The axial slot 36 may be configured to permit the writing instrument 40 to be removed from the axial slot 36 so as to permit the user to insert another or a different writing instrument 40 into the axial slot 36 to be engaged thereby. In this way, a set of writing instruments 40 may be utilized by the user of the writing device 10, as desired. For example, the set of writing instruments 40 may include each instrument 40 in the set providing a different color, different font size (i.e, tip size), and/or different ink consistency.

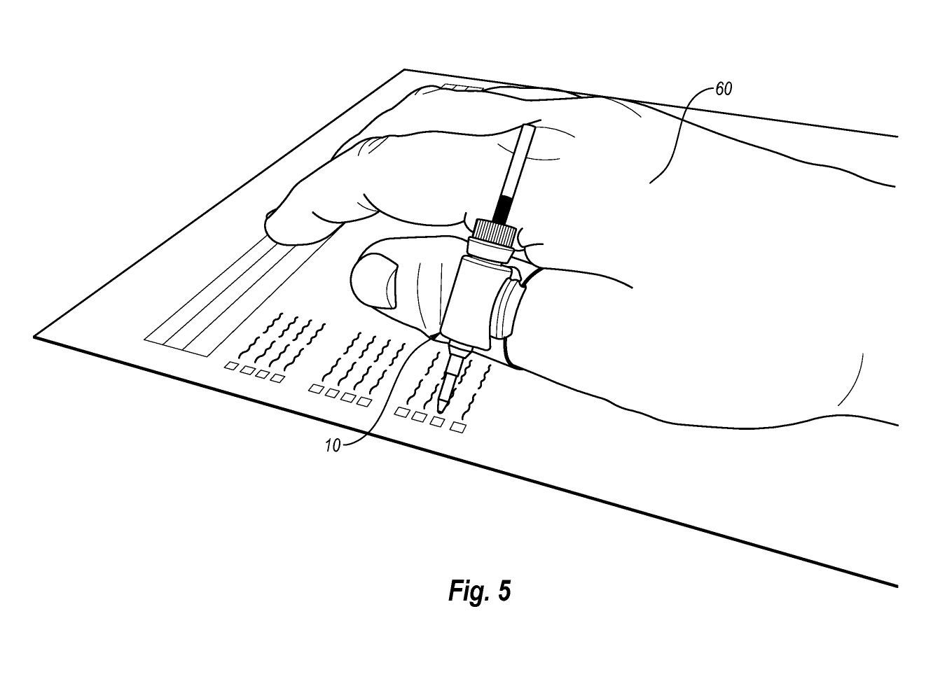

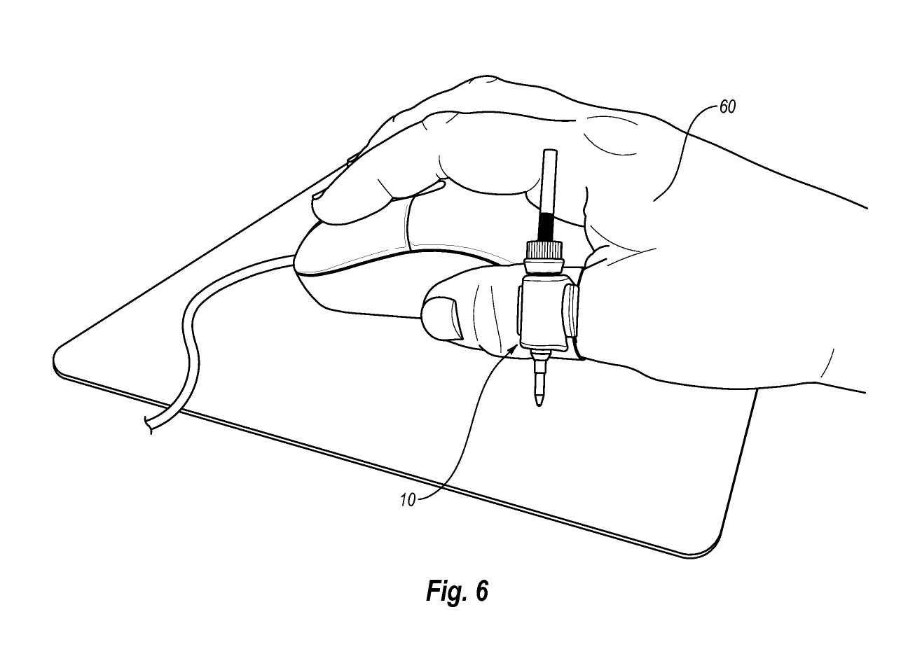

Embodiments of the adjustable writing device 10 may further comprise the instrument engaging member 30 being configured to position the writing instrument 40 substantially orthogonal to the axis 26 of the finger engaging member 20, such that an axis 46 of the writing instrument 40 is substantially orthogonal to the axis 26 of the digit engaging member 20. In this way, the writing instrument 40 may be positioned substantially orthogonally to the axis of the digit, and thus the axis of the phalange (or finger), upon which the device 10 is deployed by the user 60, as depicted in FIGS. 5 and 6. As depicted in FIG. 5, the device 10 may be coupled to the phalange of the thumb so as to not interfere with the distal end of the thumb and the fingers combining to utilize a tool, such as a pen, pencil, or other writing instrument, not depicted. At any rate, FIG. 5 demonstrates that the device 10 may not interfere with other normal operations of the thumb and fingers. As depicted in FIG. 5, the device 10 may be coupled to the phalange of the thumb so as to not prevent the thumb, fingers, and hand of the user 60 from resting in a comfortable position, such as a resting position with portions of the palm, thumb, and fingers resting on the surface. As depicted in FIG. 6, the device 10 may be coupled to the phalange of the thumb so as to not prevent the thumb, fingers, and hand of the user 60 from utilizing and competently operating components such as a mouse of a computer system, from typing on a keyboard of a computer system, or from other similar hand-required, or finger-manipulation tasks.

Embodiments of the adjustable writing device 10 may further comprise the instrument engaging member 30 being configured to twist, spin, rotate, or otherwise pivot with respect to the digit engaging member 20 to reposition the writing instrument 40 such that the axial length of the writing instrument 40 is substantially parallel with the axis 26 of the finger engaging member 20, or substantially parallel with the axial length of the digit on which the device 10 is configured. The instrument engaging member 30 may be configured to “click” into place in either the orthogonal or parallel configurations described above. In other words, once positioned at either the parallel or orthogonal configuration, the instrument engaging member 30 may be prevented from pivoting or releasing therefrom without user input, user operation, or user release.

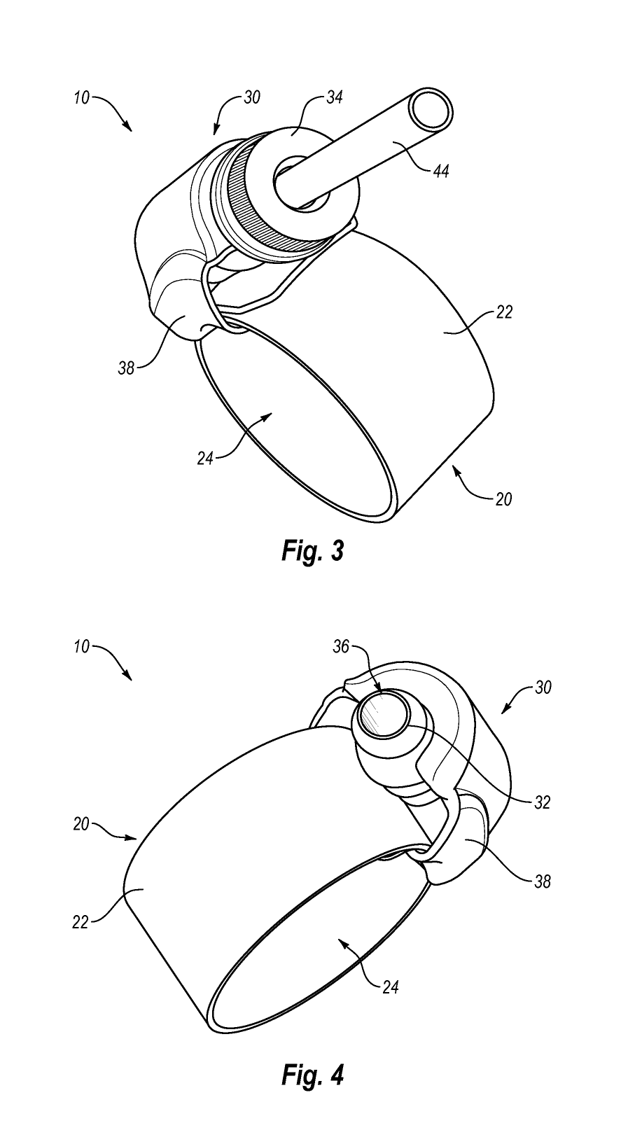

With particular reference now to FIGS. 2-4, embodiments of the device 10 may further comprise the writing utensil 40 being comprised of a writing tip 42 and a cartridge 44. The cartridge 44 may be configured to house ink, pigments, dyes, liquids, pastes, or other marking material that may be utilized by the device 10 to write or otherwise mark on objects. The cartridge 44 may be configured to functionally communicate with the instrument engaging member 30 to pass the ink, pigments, dyes, liquids, pastes, or other marking material to the writing tip 42 that may be configured to receive the material from the cartridge and write or otherwise mark on objects and/or surfaces, as desired by the user. The writing tip 42 may be configured to functionally communicate with the opposing end of the instrument engaging member 30 to receive the ink, pigments, dyes, liquids, pastes, or other marking material from the cartridge 44 through the instrument engaging member 30.

Accordingly, embodiments of the adjustable writing device 10 may further comprise the instrument engaging member 30 further comprising a writing tip engaging member 32 and a cartridge engaging member 34. The writing tip engaging member 32 may be configured to functionally engage the writing tip 42. Likewise the cartridge engaging member 34 may be configured to functionally engage the cartridge 44. In this way, the writing tip 42 may be releasably and repeatedly coupled to the instrument engaging member 30 via the writing tip engaging member 32. Further, the cartridge 44 may be releasably and repeatedly coupled to the instrument engaging member 30 via the cartridge engaging member 34. In this way, different cartridges 44 holding ink, pigments, dyes, liquids, pastes, or other marking material of various quantity, quality, color, consistency, or other characteristic may be coupled to or removed from the instrument engaging member 30, as desired by the user. In like manner, different writing tips 42 of different size, font, type, or shape may be coupled to or removed from the instrument engaging member 30, as desired by the user. As a result, the user may customize the adjustable writing device 10 according to the specific want or need.

Embodiments of the adjustable writing device 10 may be worn on the thumb of the user, such that marks can be made on surfaces without the need for the user to pick up a writing utensil every time a mark must be made on the surface. Further, the user may move his/her hand in such a way as to mark text, letters, images, and/or designs on the same surface as needed. To do so, the user may desire to place the thumb against the palm of the hand, or other proximate surface of the hand, to hold the device 10 in place between the thumb and the hand while exerting force on the device 10 to cause the writing tip 42 to move in such a motion as to leave the desired leave marks, text, images, or designs.

The components defining the above-described adjustable writing device 10 may be formed of any of many different types of materials or combinations thereof that can readily be formed into shaped objects provided that the components selected are consistent with the intended operation of a writing instrument of the type disclosed herein. For example, and not limited thereto, the components may be formed of: rubbers (synthetic and/or natural) and/or other like materials; glasses (such as fiberglass) carbon-fiber, aramid-fiber, any combination thereof, and/or other like materials; polymers such as thermoplastics (such as ABS, Fluoropolymers, Polyacetal, Polyamide; Polycarbonate, Polyethylene, Polysulfone, and/or the like), thermosets (such as Epoxy, Phenolic Resin, Polyimide, Polyurethane, Silicone, and/or the like), any combination thereof, and/or other like materials; composites and/or other like materials; metals, such as zinc, magnesium, titanium, copper, iron, steel, carbon steel, alloy steel, tool steel, stainless steel, aluminum, any combination thereof, and/or other like materials; alloys, such as aluminum alloy, titanium alloy, magnesium alloy, copper alloy, any combination thereof, and/or other like materials; any other suitable material; and/or any combination thereof.

Furthermore, the components defining the above-described adjustable writing device 10 may be purchased pre-manufactured or manufactured separately and then assembled together. However, any or all of the components may be manufactured simultaneously and integrally joined with one another. Manufacture of these components separately or simultaneously may involve extrusion, pultrusion, vacuum forming, injection molding, blow molding, resin transfer molding, casting, forging, cold rolling, milling, drilling, reaming, turning, grinding, stamping, cutting, bending, welding, soldering, hardening, riveting, punching, plating, 3-D printing and/or the like. If any of the components are manufactured separately, they may then be coupled with one another in any manner, such as with adhesive, a weld, a fastener (e.g. a bolt, a nut, a screw, a nail, a rivet, a pin, and/or the like), wiring, any combination thereof, and/or the like for example, depending on, among other considerations, the particular material forming the components. Other possible steps might include sand blasting, polishing, powder coating, zinc plating, anodizing, hard anodizing, and/or painting the components for example.

While this disclosure has been described in conjunction with the specific embodiments outlined above, it is evident that many alternatives, modifications and variations will be apparent to those skilled in the art. Accordingly, the preferred embodiments of the present disclosure as set forth above are intended to be illustrative, not limiting. Various changes may be made without departing from the spirit and scope of the present disclosure, as required by the following claims. The claims provide the scope of the coverage of the present disclosure and should not be limited to the specific examples provided herein.

What is claimed is:

1. An adjustable holder for a writing instrument, the holder comprising:
a digit engaging member, wherein the digit engaging member has an axis and an adjustable diameter for functionally engaging a portion of a user's digit without substantially impeding articulation of the digit; and
an instrument engaging member functionally coupled to the digit engaging member, the instrument engaging member configured to receive the writing instrument,
wherein under a condition the writing instrument is functionally engaged by the instrument engaging member, a length of the writing tip of the writing instrument is oriented substantially orthogonally to the axis of the digit engaging member.

2. The holder of claim 1, wherein the digit engaging member is configured to repeatedly and releasably engage the portion of the user's digit.

3. The holder of claim 1, wherein the digit engaging member engages the user's digit between neighboring joints of the digit without impeding articulation of the digit.

4. The holder of claim 1, wherein the instrument engaging member is configured to rotate with respect to the digit engaging member between an orthogonal position wherein the length of the writing tip and the axis of the digit engaging member are substantially orthogonal to one another and a parallel position wherein the length of the writing tip and the axis of the digit engaging member are substantially parallel with one another.

5. The holder of claim 1, wherein the instrument engaging member is configured to releasably and repeatedly couple to the digit engaging member.

6. The holder of claim 1, wherein the instrument engaging member is configured to releasably and repeatedly engage the writing instrument.

7. The holder of claim 1, wherein the length of the writing tip of the writing instrument is fixedly oriented substantially orthogonally to the axis of the digit engaging member.

8. The holder of claim 1, wherein the writing device is inserted on a thumb of the user.

9. An adjustable writing device, the writing device comprising:
a digit engaging member, wherein the digit engaging member has an adjustable diameter for functionally engaging a portion of a user's digit without substantially impeding articulation of the digit;
an instrument engaging member functionally coupled to the digit engaging member;
a writing tip functionally coupled to the instrument engaging member; and
a cartridge adapted to communicate with the instrument engaging member to allow ink within the cartridge to be dispensed from the writing tip.

10. The adjustable writing device of claim 9, wherein the digit engaging member is configured to repeatedly and releasably engage the portion of the user's digit.

11. The adjustable writing device of claim 9, wherein the digit engaging member engages the user's digit between neighboring joints of the digit without impeding articulation of the digit.

12. The adjustable writing device of claim 9, wherein the instrument engaging member is configured to rotate with respect to the digit engaging member.

13. The adjustable writing device of claim 9, wherein the instrument engaging member is configured to releasably and repeatedly couple to the digit engaging member.

14. The adjustable writing device of claim 9, wherein the writing tip is configured to releasably and repeatedly couple to the instrument engaging member.

15. The adjustable writing device of claim 9, wherein the cartridge is configured to releasably and repeatedly couple to the instrument engaging member on an opposing end of the instrument engaging member from the writing tip.

16. The adjustable writing device of claim 9, wherein the writing device is inserted on a thumb of the user.

17. A method of utilizing a writing device, the method comprising:
coupling a writing instrument to the writing device;
coupling the writing device to a digit on a hand of a user such that a length of the writing instrument is oriented substantially orthogonally to an axis of the digit on which the device is coupled; and
operating the writing instrument by movement of the digit.

18. The method of claim 17, further comprising a digit engaging member defining an opening and the opening defining an axis, wherein the coupling the writing device on a digit on a hand of a user further comprises inserting the digit into the opening, the opening being configured to repeatedly and releasably couple the writing device to the digit.

19. The method of claim 17, wherein the coupling a writing instrument to the writing device further comprises inserting the writing instrument through a sleeve defined by the writing device, the sleeve being configured to engage the writing instrument.

20. The method of claim 17, wherein the operating the writing device further comprises: inserting the writing device on a user's thumb; moving the thumb to make one or more markings on a first object; and operating a second object in the user's hand having the device thereon between the one or more markings without removing the device from the user's thumb.
